(19) United States
(12) Patent Application Publication
(10) Pub. No.: US 2006/0043630 A1
(43) Pub. Date: Mar. 2, 2006

(54) [METHOD OF MANUFACTURING POWDER PUFF]

(75) Inventor: Chih-Chun Hsu, TAIPEI (TW)

Correspondence Address: CHIH-CHUN HSU, 2F-4, NO. 148, SEC. 4, CHUNG HSIAO EAST ROAD, TAIPEI, TW

(73) Assignee: Chih-Chun Hsu, HSIN-YI DISTRICT, TAIPEI CITY (TW)

(21) Appl. No.: 10/711,199

(22) Filed: Sep. 1, 2004

(51) Int. Cl. B29C 39/12

(52) U.S. Cl. 264/159; 264/162; 264/245

(57) ABSTRACT

A method of manufacturing powder puff is provided. First, a plurality of moulds of different sizes is provided. A smaller mould is used to form a powder puff block. Next, the powder puff block is placed into a mould cavity of a larger mould. Next, a different colored powder puff material charged into the mould cavity of the larger mould. Next, the different colored powder puff material and the powder puff block are heated after the powder puff material solidifies in the mould cavity to fuse the different colored powder puff material and the powder puff block to form a one-piece powder puff log. Next, the one-piece powder puff log is cut to obtain a plurality of pieces of raw-powder-puffs. The raw-powder-puffs are polished to obtain finished-puffs.

### BACKGROUND OF THE INVENTION

1. The field of the invention

The present invention relates to a method of manufacturing powder puff, and more particularly, to a method of using different colored powder puff material and moulds of various sizes and shapes to produce attractive and colorful powder puff and thereby add value to the powder puff.

2. Description of Related Art

Human beings like to use all kinds of decorative items, clothes or makeup to demonstrate elegance and beauty, or even the style of different cultures. Different life-style and environments, cultures and backgrounds usually express esthetic sense in the different ways. In the early 60's and 70's, before the eastern and western cultures intermingled, the way oriental demonstrated beauty was more conservative, simple and succinct, and the way western demonstrated beauty was more colorful, exciting and brighter. After 80's and 90's, the intermingling of the eastern and the western cultures paved a way for the oriental people to experience the western culture, the oriental gradually accepted the free and unbinding life-style of the western people. And, the oriental people started to express beauty in the same way as the western people. The western life-style has greatly immersed into the eastern society and the westerns products greatly attracted men and women, and also the older and younger generations. The bold expression of the eastern has proved that the western culture has deeply influenced the eastern culture recently.

The ways of expressing the beauty, for example, using cosmetic is one of the most effective one. Usually the user make up using the powder puff, however, the conventional powder puffs lack any special design and have the following defects.

1. Single color and simple appearance and therefore are too much out fashion to catch up with today's stylish trends.

2. The simple and single color cannot provide attractive and elegant outlook to the powder puffs.

The old fashion has deeply influenced the design of the conventional powder puff and the color and the outlook are not being improved. Therefore, to make the powder puff using a variety of colored powder puff and in attractive size and shape to the external outlook for catching up with the trends is an important issue for the manufacturers in the field.

### SUMMARY OF INVENTION

Accordingly, in the view of the foregoing, the present inventor makes a detailed study of related art to evaluate and consider, and uses years of accumulated experience in this field, and through several experiments, to create a new powder puff. The present invention provides an innovated attractive powder puff with attractive colors and elegant outlook.

According to an aspect of the present invention, powder puff blocks in different sizes, shapes and colors are produced by using a plurality of moulds of different sizes and shapes. The smaller mould is used for making the powder puff block and then the powder puff block is placed into a larger mould charged with a powder puff material of different color. Thus, a powder puff with various colors and shapes giving an attractive and elegant appearance to the cosmetic product is obtained and thereby add value to the cosmetic product.

According to another aspect of the present invention, a certain quantity of the powder puff material is charged into the larger mould and a pre-formed powder puff block is inserted into the larger mould with the powder puff material. After the powder puff material solidifies together with the inserted powder puff block, the powder puff material and the powder puff block are heated to fuse them as one-piece powder puff log.

According to another aspect of the present invention, a plurality of moulds of various sizes and different shapes or same shape are used for manufacturing the powder puff with a variety of size, shape and colors.

According to another aspect of the present invention, the smaller mould is placed into the larger mould and then the powder puff material is charged into the larger mould. After the powder puff material solidifies, the smaller mould is removed leaving a space in the larger mould and then the powder puff material of different color is charged into the space. Finally, after the powder puff material solidifies and fused together forming a powder puff log, the powder puff log is cut into a plurality of powder puffs of desired size and the edges of the powder puffs are polished.

### BRIEF DESCRIPTION OF DRAWINGS

For a more complete understanding of the present invention, reference will now be made to the following detailed description of preferred embodiments taken in conjunction with the following accompanying drawings.

FIG. 1 is an elevational view showing a step of charging a powder puff material into a smaller mould according to an embodiment of the present invention.

FIG. 2 is an exploded view showing a larger mould and a powder puff block according to an embodiment of the present invention.

FIG. 3 is an elevational view showing a step of charging a different colored powder puff material into a larger mould according to an embodiment of the present invention.

FIG. 4 is an elevational view showing a step of cutting the powder puff log according to an embodiment of the present invention.

FIG. 5 is an exploded view of a step of manufacturing powder puff according to another embodiment of the present invention.

FIG. 6 is an elevational view of a step of manufacturing powder puff according to another embodiment of the present invention.

FIG. 7 is an elevational view of a step of cutting a power puff log according to another embodiment of the present invention.

FIG. 8 is an elevational view of a step of cutting a power puff log according to another embodiment of the present invention.

FIG. 9 is an elevational view of a smaller mould according to an embodiment of the present invention.

FIG. 10 is an exploded view of a larger mould and a powder puff block according to an embodiment of the present invention.

FIG. 11 is an elevational view of a powder puff log according to another embodiment of the present invention.

FIG. 12 is an exploded view showing a step of manufacturing powder puff according to another embodiment of the present invention.

FIG. 13 is an exploded view showing a step of manufacturing powder puff according to another embodiment of the present invention.

FIG. 14 is an elevational view showing a method of manufacturing powder puff according to another embodiment of the present invention.

### DETAIL DESCRIPTION

Reference will be made in detail to the preferred embodiments of the invention, examples of which are illustrated in the accompanying drawings. Wherever possible, the same reference numbers are used in the drawings and the description to refer to the same or like parts.

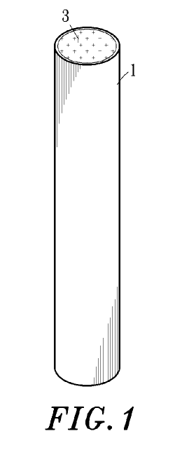

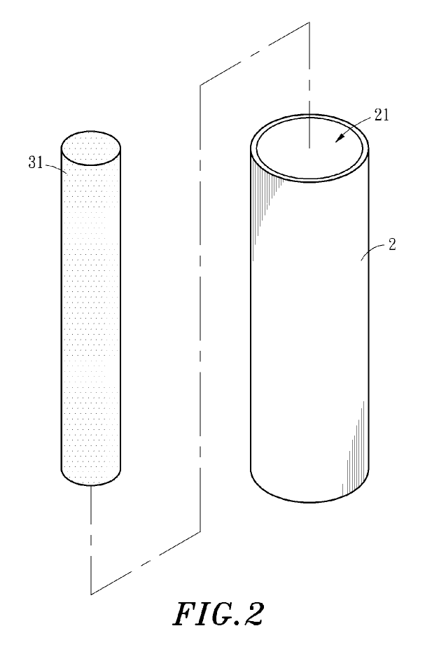

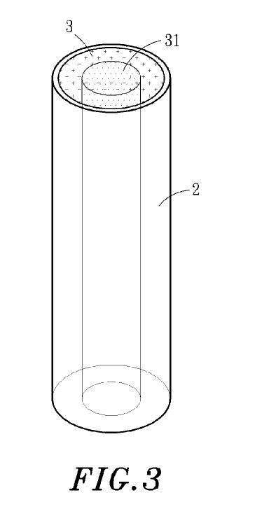

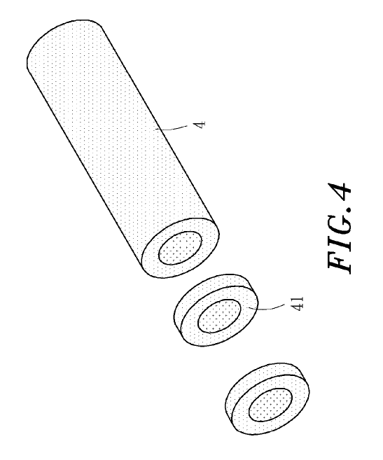

The method of manufacturing the powder puff is described with reference to FIGS. 1, 2, 3 and 4 as follows. First, a plurality of moulds 1 and 2 of different sizes and shapes or of same shape are provided, wherein a powder puff material 3 can be charged into the smaller mould 1 to form a powder puff block 31. Next, the powder puff block 31 is placed into the mould cavity 21 of the larger mould 2. Next, a different colored powder puff material 3 is charged into the mould cavity 21 of the larger mould 2. After the different colored powder puff material 3 charged in the mould cavity 21 of the larger mould 2 is solidified, the different colored powder puff material 3 and the powder puff block 31 are heated to fuse them into a single piece powder puff log 4. Next, the powder puff log 4 is sliced or cut and the edges of the sliced pieces of powder puff log 4 are polished to produce the cosmetic powder puffs 41. Thus, the finished cosmetic powder puffs 41 are manufactured.

As described in the above process, the powder puff block 31 is first placed into the mould cavity 21 of the larger mould 2, wherein the different colored powder puff material 3 is charged into the smaller mould 1 to combine them into the powder puff block 31 and the different colored powder puff material 3 is charged into the mould cavity 21 of the larger mould 2. After the different colored powder puff material 3 are solidified, a heating process is carried out to fuse the powder puff material 3 to form a single piece powder puff log 4 with different colors and attractive outlook. The different colored powder puff material 3 can be made of sponge or latex, or any other material suitable to produce the powder puffs 41.

The plurality of moulds 1 and 2 of different sizes and shapes, or of same shape, can create layers in the cosmetic powder puffs 41 for making the final product beautiful and attractive.

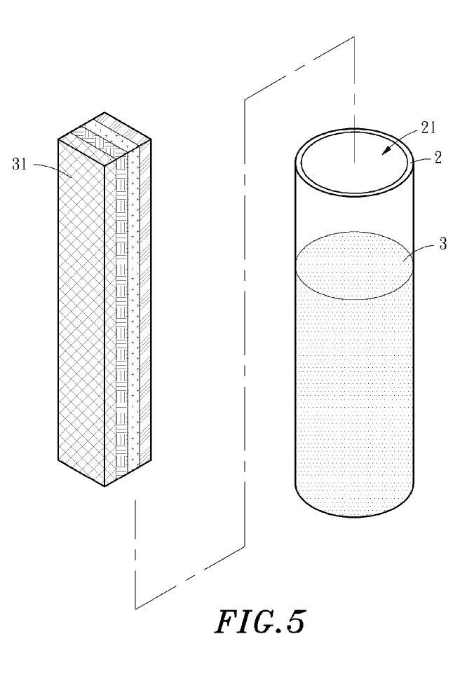

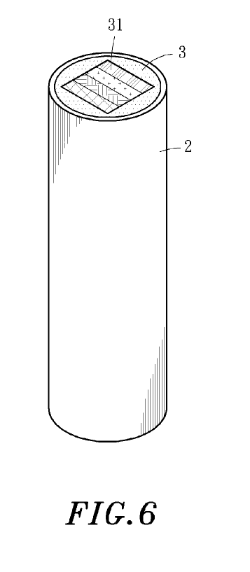

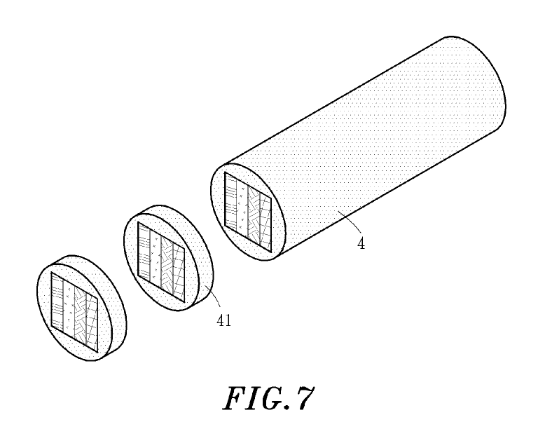

Referring to FIGS. 5, 6 and 7, a certain quantity of the different colored powder puff material 3 is charged into mould cavity 21 of the larger mould 2 and the pre-formed powder puff block 31 is inserted into the mould cavity 21 charged with the different colored powder puff material 3. After the different colored powder puff material 3 in the mould cavity 21 is solidified, the different colored powder puff material 3 and the powder puff block 31 are heated to fuse the mould cavity 21 with the powder puff block 31 to form the powder puff log 4. Finally, the powder puff log 4 is sliced to form the cosmetic powder puffs 41 with various colors.

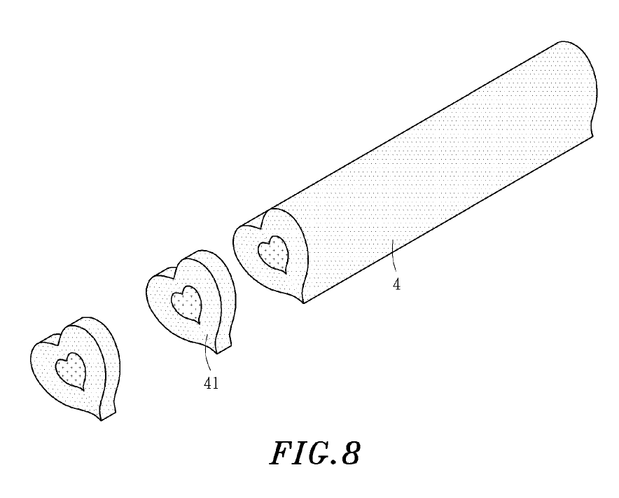

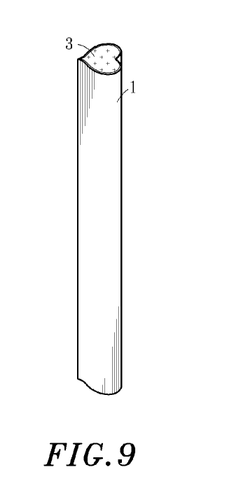

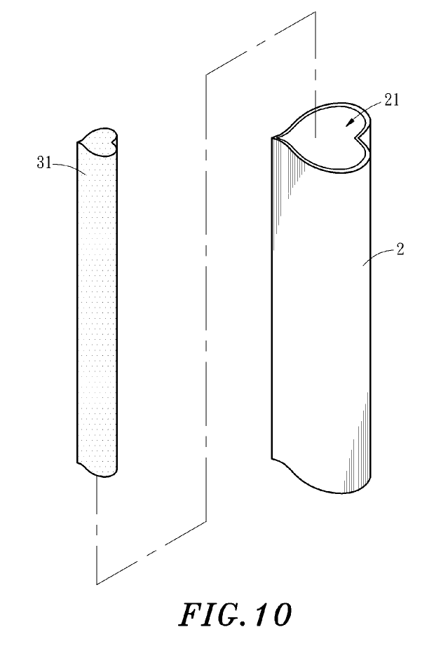

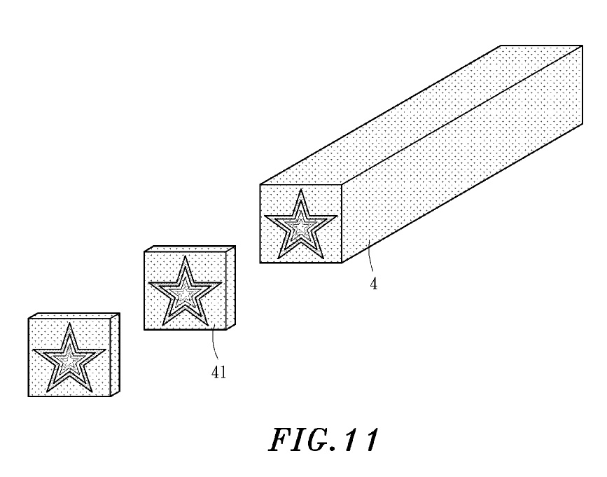

Referring to FIGS. 8, 9, 10 and 11, the plurality of moulds 1 and 2 can be in different shapes into which the different colored powder puff material 3 are charged to produce the powder puff block 31 in the different or same shape, and the powder puff block 31 can be assembled in an orderly manner into the mould cavity 21 of the larger mould 2 to produce the powder puff log 4 having a variety of attractive different colored powder puff materials 3 in a variety of attractive sizes and shapes. Subsequently, the powder puff log 4 is sliced or cut and the edges of the sliced piece are polished to produce the powder puffs 41 having layers.

The above cosmetic powder puff 41 is a combination of a plurality of different colored powder puff materials 3 to provide the consumers the powder puff 41 with a variety of different colored powder puff 41 with better visual effects and selection of colors to achieve better makeup result. Accordingly, the present invention provides the consumers with a wide selection of the powder puffs 41 of various colors and outlooks. Thus, the product of the present invention is quite attractive and appealing to the consumers to achieve better sales. Correspondingly, the productivity can be upgraded to meet the impact WTO entry. The various colors of the powder puffs 41 of the present invention are substantially attractive compared to a single color and shape of the conventional powder puff. With the colorful, vivid and beautiful outlook of the powder puff 41, the production thereof can be upgraded to catch up with the expectation of the whole social economics.

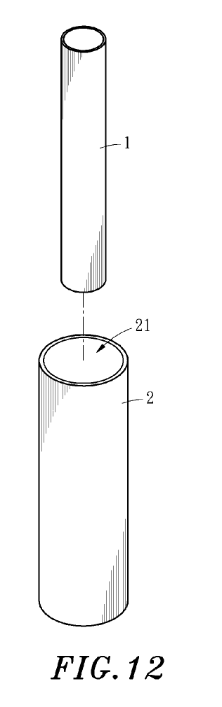

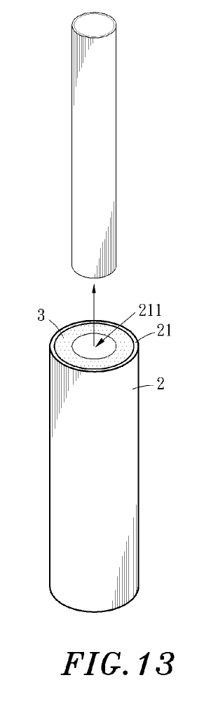

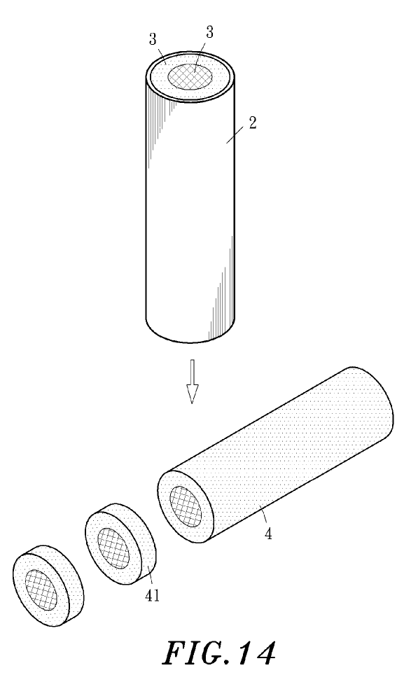

The method of manufacturing the powder puff 41 according to another embodiment of the present embodiment is described with reference to FIGS. 12, 13 and 14 as follows. First, the smaller mould 1 is placed into the mould cavity 21 of the larger mould 2 and then the powder puff material 3 is charged into the mould cavity 21 of the larger mould 2. After the different colored powder puff material 3 is solidified in the mould cavity 21 of the larger mould 2, the smaller mould 1 is removed from the mould cavity 21 of the larger mould 2 leaving a space 211 therein. Next, the different colored powder puff material 3, for example, comprised of a different color is charged into the space 211 of the mould cavity 21. Thus, a single piece powder puff log 4 with various colors is produced. Finally, the powder puff log 4 is sliced or cut and the edges of each sliced or cut pieces are polished to produce the powder puff 41.

According to another embodiment of the present invention, the smaller mould 1 is placed into the mould cavity 21 of the larger mould 2 and then the powder puff material 3 is charged into the mould cavity 21 of the larger mould 2. After the powder puff material 3 is solidified, the smaller mould 1 is removed from the mould cavity 21 of the larger mould 2 leaving the space 211. Next, a different colored powder puff material 3 is charged into the space 211 and after the different colored powder puff material 3 is solidified, it is heated to form the powder puff log 4. Thus, the powder puff log 4 with various colors is produced. Finally, the powder puff log 4 is sliced or cut and polished to produce the powder puffs 41.

Accordingly, the powder puff of the present invention has the following advantages.

1. The powder puff of the present invention has various colors and different shapes to present elegance and vividness for satisfying the consumers' fashion desire.

2. The plurality of the moulds can be designed in various colors and shapes to produce the powder puff with the different attractive appearance to increase the value of the powder puff.

3. The powder puff material can be of different colors and coordinate with the shape of the moulds to provide better and modern appearance to the powder puff.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

What is claimed is:

1. A method of manufacturing powder puff, comprising:
(a) providing a plurality of moulds of different sizes, wherein a smaller mould is used to form a powder puff block;
(b) placing said powder puff block into a mould cavity of a larger mould;
(c) charging a different colored powder puff material into said mould cavity of said larger mould;
(d) heating said different colored powder puff material and said powder puff block after said powder puff material solidifies in said mould cavity to fuse said different colored powder puff material and said powder puff block to form a one-piece powder puff log;
(e) cutting said one-piece powder puff log to obtain a plurality of pieces of raw-powder-puffs; and
(f) polishing said raw-powder-puffs to obtain a plurality of finished-powder-puffs.

2. The method of manufacturing powder puff according to claim 1, wherein said plurality of moulds is of various sizes and shapes.

3. The method of manufacturing powder puff according to claim 1, wherein said plurality of moulds is of various sizes and has a shape.

4. The method of manufacturing powder puff according to claim 1, wherein a pre-formed powder puff block is inserted into said mould cavity of said larger mould charged with said different colored powder puff material to form said powder puff in various colors and shapes.

5. The method of manufacturing powder puff according to claim 1, wherein said different colored powder puff material comprises sponge.

6. The method of manufacturing powder puff according to claim 1, wherein said different colored powder puff material comprises latex.

7. The method of manufacturing powder puff according to claim 1, wherein said different colored powder puff material comprises various colors.

8. A method of manufacturing powder puff, comprising:
(a) providing a plurality of moulds of different sizes, wherein a smaller mould into a module cavity of a larger mould;
(b) charging a powder puff material into said mould cavity of said larger mould;
(c) heating said powder puff material after said powder puff material solidifies in said mould cavity of said larger mould and removing said smaller mould from said mould cavity of larger mould leaving a space therein;
(d) charging a powder puff material of various color into said space in said mould cavity of larger mould to form a one-piece powder puff log;
(e) cutting said one-piece powder puff log to obtain a plurality of raw-powder-puffs with various colors; and
(f) polishing said raw-powder-puffs with various colors to obtain finished-powder-puffs.

9. The method of manufacturing powder puff according to claim 8, wherein said plurality of moulds is of various sizes and shapes.

10. The method of manufacturing powder puff according to claim 8, wherein said plurality of moulds is of various sizes and of a shape.
